(19) United States
(12) Patent Application Publication
(10) Pub. No.: US 2014/0379374 A1
(43) Pub. Date: Dec. 25, 2014

(54) Management of Medical Information

(71) Applicant: Javier Vinals, Madrid (ES)

(72) Inventor: Javier Vinals, Madrid (ES)

(21) Appl. No.: 13/956,757

(22) Filed: Aug. 1, 2013

Related U.S. Application Data
(62) Division of application No. 13/921,366, filed on Jun. 19, 2013.

(51) Int. Cl. G06F 19/00

(52) U.S. Cl. CPC G06F 19/322
USPC 705/3

(57) ABSTRACT

According to one embodiment, a system includes one or more processors operable to receive one or more clinical packets, each clinical packet including content associated with the health of one of a plurality of individuals. For each of the clinical packets, the processors are also operable to parse data associated with the content; determine one or more classifications for the content; associate the content with the classifications; and store the content and the associated classifications as medical information for the associated one of the plurality of individuals. The processors are further operable to receive a request to view the medical information associated with a first individual, and determine whether the requestor has been given one or more of a plurality of permission levels by the first individual. The processors are further operable to communicate for display one or more portions of the medical information.

### RELATED APPLICATION

This is a divisional application of U.S. application Ser. No. 13/921,366 filed Jun. 19, 2013, entitled “Management of Medical Information.”

### TECHNICAL FIELD

This disclosure relates generally to the field of medicine and more specifically to management of medical information.

### BACKGROUND

Traditionally, when a patient visits a new health service provider (e.g., a doctor), the doctor may not have access to the patient's previous medical information (other than what the patient can remember). Furthermore, even when a patient's medical information may be in electronic form in a health information exchange (HIE) system, the doctor still may not have access to the patient's previous medical information for various reasons. As such, traditional healthcare systems may be deficient.

### SUMMARY OF THE DISCLOSURE

According to one embodiment, a system includes a memory and one or more processors coupled to the memory. The processors are operable to receive one or more clinical packets, each clinical packet including content associated with the health of one of a plurality of individuals. For each of the clinical packets, the processors are also operable to parse data associated with the content; based on the parsing, determine one or more classifications for the content; associate the content with the classifications; and store, in the memory, the content and the associated classifications as medical information for the associated one of the plurality of individuals. The processors are further operable to receive a request to view the medical information associated with a first individual. The processors are further operable to determine whether the requestor has been given one or more of a plurality of permission levels by the first individual, each of the one or more permission levels being associated with a portion of the medical information of the first individual. The processors are further operable to, following the determination that the requestor has been given one or more of the plurality of permission levels, communicate for display the one or more portions of the medical information associated with the one or more of the permission levels given to the requestor.

Certain embodiments of the disclosure may provide one or more technical advantages. For example, the clinical packets may be received from one or more communication channels (e.g., e-mail, voicemail, fax, cloud services, Short Message Service (SMS), Multimedia Messaging Service (MMS), etc.). As such, the management of medical information may not be limited to information that is only communicated by one type of communication channel. As another example, one or more portions of the medical information for a patient may be viewed by a requestor if the requestor has been given an associated permission level from the patient. As such, any health service provider (e.g., any health service provider in the world) may be able to access the patient's medical information if the patient grants permission to the health service provider. Thus, the patient may visit any health service provider, and that health service provider may be able to access the patient's medical information.

Certain embodiments of the disclosure may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present disclosure and its features and advantages, reference is now made to the following description, taken in conjunction with the accompanying drawings, in which:

FIG. 1 illustrates a system that manages medical information according to one embodiment of the disclosure;

FIG. 2A illustrates an example of a clinical packet according to one embodiment of the disclosure;

FIG. 2B illustrates an example of a report according to one embodiment of the disclosure;

FIG. 3 illustrates an example of a graphical user interface according to one embodiment of the disclosure;

FIG. 4 illustrates another example of a graphical user interface according to one embodiment of the disclosure;

FIG. 5 illustrates another example of a graphical user interface according to one embodiment of the disclosure; and

FIG. 6 illustrates a method for management of medical information according to one embodiment of the disclosure.

### DETAILED DESCRIPTION OF THE DRAWINGS

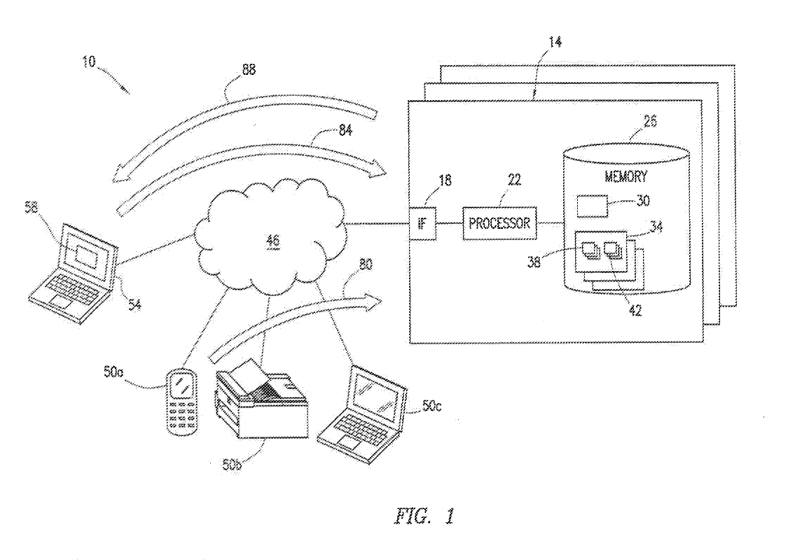

Embodiments of the present disclosure are best understood by referring to FIGS. 1-6 of the drawings, like numerals being used for like and corresponding parts of the various drawings.

FIG. 1 illustrates a system 10 that manages medical information according to one embodiment of the disclosure. As illustrated, system 10 includes a management device 14 that receives clinical packets from communication devices 50. Based on these clinical packets, management device 14 may generate medical information for one or more patients. Furthermore, upon receiving a request to view medical information for a particular patient, management device 14 may determine whether the requestor has been given one or more permission levels by the patient. If so, management device 14 may communicate at least a portion of the medical information for view by the requestor. As such, system 10 may allow medical information for a patient to be generated based on clinical packets received from any number of communication channels (e.g., e-mail, voicemail, video, fax, cloud services, SMS, MMS, etc.) and may further allow portions of the medical information for a patient to be viewed by a requestor if the requestor has been given an associated permission level from the patient. Therefore, the health service provider may be able to access the patient's medical information.

Traditionally, healthcare systems may be deficient in their ability to provide access to medical information when needed. For example, a patient (e.g., Patient A) may visit a hospital due to a particular ailment. If the hospital is in a different city from which the patient lives, the patient may be treated by a doctor (e.g., Doctor B) who has never treated the patient before. Furthermore the doctor may not have access to the patient's previous medical information. Thus, the doctor may be required to rely only on the patient's memory regarding their previous medical information (e.g., previous ailments, allergies, current and past medications, etc.). Additionally, when the patient subsequently visits their normal doctor (e.g., Doctor A), that doctor may not have any access to the medical information associated with the patient's treatment by Doctor B.

In order to attempt to solve this lack of access to medical information, some traditional healthcare systems may utilize electronic medical records (EMRs) and HIE systems that may be designed to provide better access to medical information. Unfortunately, these traditional healthcare systems may also be deficient. First, different HIE systems may be incompatible with each other. As such, if a portion of a patient's medical information is stored on a first HIE system and another portion of the patient's medical information is stored on a second HIE system, the doctor may be required to access both systems in order to access all of the information. Furthermore, the patient may be identified by a different identifier on each HIE system, which may further prevent incorporation of all of the medical information. For example, if a first HIE system identifies the patient as patient 718 (e.g., assigned by a first hospital) while the second HIE system identifies the patient as patient 290 (e.g., assigned by the patient's family doctor), incorporation of the medical information into a single system may create two different patients (e.g., patient 718 and patient 290), as opposed to the one patient the records actually refer to. Second, before the doctor can even attempt to access different HIE systems, the doctor may be required to install different HIE-specific software on their computer systems. This can be both costly and cumbersome. Third, the HIE systems may prevent proper patient referrals. For example, if a doctor wanted to refer their patient to a specialist, the doctor would have to know the HIE system that the specialist is using, and the doctor would also have to upload the relevant medical information to that particular HIE system (in addition to uploading it to their own HIE system). If the doctor was unable (or unwilling to do so), the specialist would not have access to the proper medical information when the patient arrives for treatment.

One or more of these deficiencies, however, may be addressed by system 10 of FIG. 1. As illustrated, system 10 includes management device 14. Management device 14 may represent any components that manage medical information for one or more patients, and may be implemented using any suitable combination of hardware, firmware, and software. Management device 14 may include a network server, any remote server, a mainframe, a host computer, a workstation, a web space server, a personal computer, a file server, or any other device operable to manage medical information for one or more patients. The functions of management device 14 may be performed by any combination of one or more servers or other components at one or more locations. If the module is a server, the server may be a private server, and the server may be a virtual or physical server. The server may include one or more servers at the same or remote locations. Also, management device 14 may include any component that functions as a server.

Although FIG. 1 illustrates system 10 as only including one management device 14, system 10 may include any suitable number of management devices 14. For example, system 10 may include more than one management device 14 (e.g., two, three, four, ten, 100, 1,000, 10,000, 100,000, 250,000, one million management devices 14, etc.). Furthermore, each of these management devices 14 may operate together as a single information system (e.g., a cloud-based management system).

As illustrated, management device 14 includes a network interface 18, a processor 22, and a memory 26. Network interface 18 may represent any device operable to receive information from network 46, transmit information through network 46, perform processing of information, communicate to other devices, or any combination of the preceding, and may be implemented using any suitable combination of hardware, firmware, and software. For example, network interface 18 may receive information from a communication device 50. As another example, network interface 18 may communicate medical information for display on a user device 54. Network interface 18 may represent any port or connection, real or virtual, including any suitable hardware and/or software, including protocol conversion and data processing capabilities, to communicate through a local area network (LAN), a metropolitan area network (MAN), a wide area network (WAN), a local, regional, or global communication or computer network, such as the Internet, a wireline or wireless network, an enterprise intranet, or other communication system (or a combination of these systems) that allows management device 14 to exchange information with network 46, communication devices 50, user device 54, or other components of system 10.

Processor 22 communicatively couples to network interface 18 and memory 26, and controls the operation and administration of management device 14 by processing information received from network interface 18 and memory 26. For example, processor 22 executes management device application 30 to control the operation of management device 14. Processor 22 may be a programmable logic device, a microcontroller, a microprocessor, any processing device, or any combination of the preceding.

Memory 26 stores, either permanently or temporarily, data, operational software, or other information for processor 22. Memory 26 includes any one or a combination of volatile or non-volatile local or remote devices suitable for storing information. For example, memory 26 may include random access memory (RAM), read only memory (ROM), magnetic storage devices, optical storage devices, databases (such as a Structured Query Language (SQL) database), or any other information storage device or a combination of these devices. While illustrated as including particular modules, memory 26 may include any information for use in the operation of management device 14.

As illustrated, memory 26 includes management device application 30 and one or more patient records 34. Management device application 30 may represent any suitable set of instructions, logic, or code embodied in a computer readable storage medium and operable to facilitate the operation of management device 14.

Patient records 34 may represent records of medical information for one or more patients. For example, a first patient record 34 may represent medical information records for a first patient (e.g., Patient A) while a second patient record 34 may represent medical information records for a second patient (e.g., Patient B). Memory 26 may store any number of patient records 34. For example, memory 26 may store patient records 34 for one patient, two patients, ten patients, 100 patients, 1,000 patients, 10,000 patients, 100,000 patients, 250,000 patients, one million patients, ten million patients, one hundred million patients, or any other number of patients.

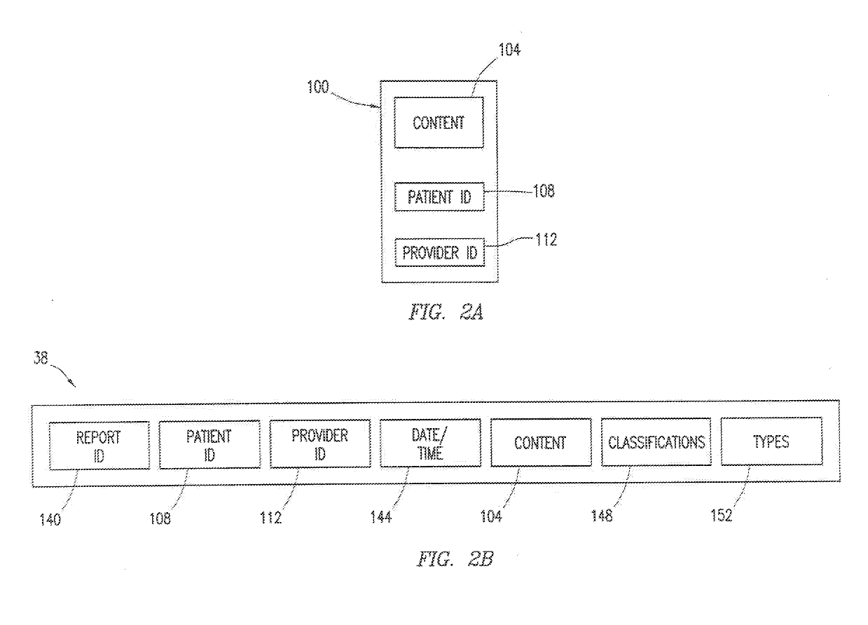

A patient record 34 may include one or more reports 38 and one or more permission levels 42. Report 38 may represent a report associated with the health of the patient. For example, if a patient broke his leg on Jan. 15, 2014, the information associated with that broken leg may be stored as one or more reports 38. In such an example, a first report 38 may include x-rays of the broken leg, a second report 38 may include medications given to the patient, a third report 38 may include information associated with the recovery of the patient, a fourth report 38 may include a further x-ray of the leg after it is healed, etc. Furthermore, although this information may be included in different reports 38, such information may also be included in a single report 38. For example, the information may be included in a single report 38 when the information is from the same health event (e.g., a health event related to a broken leg). One or more reports 38 for a patient may be an EMR provided by one or more health service providers (e.g., a doctor, a hospital, a medical testing unit, a psychiatrist, a dietician, a personal trainer, a health insurance company, any other provider of health services, or any combination of the preceding). Additionally, one or more reports 38 may be a personal health record (PHR) provided by the patient himself (e.g., the patient's family history, a new diet the patient is trying, allergies known to the patient, symptoms of an ailment, information related to previous medical related events (e.g., the patient may provide a scanned copy or a summary of a previous report or test result generated by a health service provider), data obtained by a monitoring sensor or device (e.g., temperature recording, pulse recording, physical constants recording, etc.), any other information that may be provided by the patient, or any combination of the preceding). Reports 38 for a particular patient may make up the medical information of the patient. For example, by reviewing one or more reports 38, a health service provider may be able to understand the medical information of the patient. An example of a report 38 is discussed further below with regard to FIG. 2B.

Permission levels 42 may represent permissions given by a patient so that at least a portion of the patient's medical information may be accessed. Permission levels 42 may be given by a patient to one or more health service providers so that the health service provider may access at least a portion of the patient's medical information. For example, if a particular doctor is the patient's main doctor, the patient may give that doctor full permission to access all of the patient's medical information. As another example, if the patient is visiting a dietician, the patient may only give the dietician the ability to access medical information associated with the patient's diet and food-related health. In such an example, the dietician may not be able to access medical information regarding a previous broken leg, previous psychiatric exams, or any other medical information not associated with the patient's diet and food-related health. As such, permission levels 42 may allow a patient to restrict what medical information a health service provider is able to access. Permission levels 42 may also be given by a patient to one or more family members, friends, and/or any other person or entity. As such, the patient may have the ability to allow family members (or anyone else) to access at least a portion of the patient's medical information.

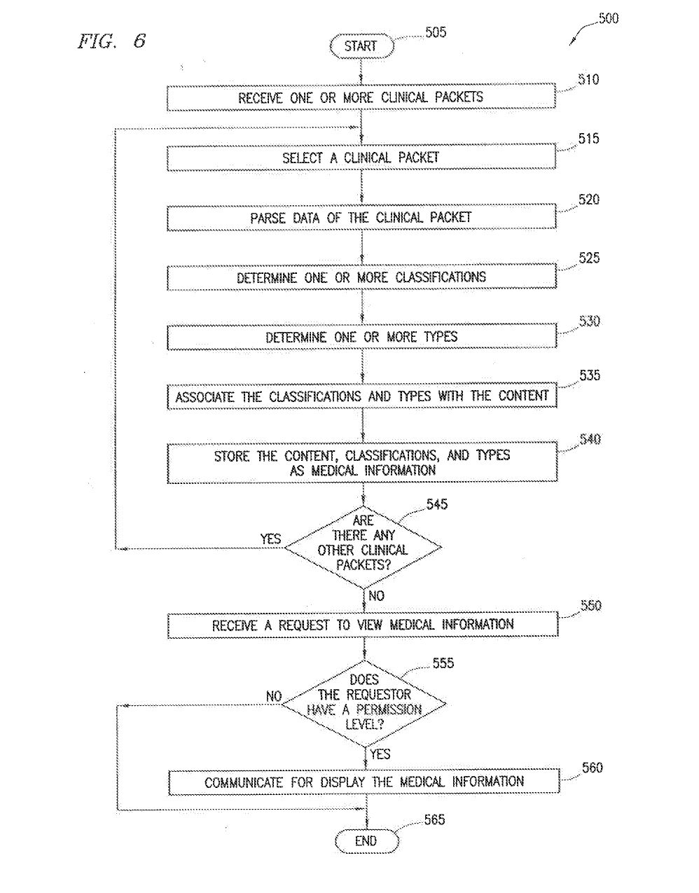

Although permission levels 42 may allow a patient to restrict what medical information a health service provider is able to access, permission levels 42 may not prevent (or may prevent) a health service provider from being able to see that a patient has a particular report 38 (even though the health service provider may not be able to access the report 38 or access any of the information in the report 38). For example, even when a health service provider does not have permission to access particular medical information (e.g., particular reports 38), the restricted reports may still be viewable by the health service provider as “blinded reports.” These blinded reports may appear as empty boxes (or any other type of GUIs) that do not include any medical information (or only very generic medical information). However, the health service provider may be able to click on (or otherwise select) the blinded report in order to request permission from the patient for access to that blinded report, as is described below with regard to FIG. 6.

A permission level 42 may allow the grantee (e.g., a health service provider, a family member, etc) of the permission level to access at least a portion of the patient's medical information. Additionally, the permission level 42 may also provide access to employees, agents, and/or consultants of the grantee. For example, if the patient gives a hospital permission to access a portion of the patient's medical information, any of the doctors, nurses, technicians, consultants, and/or any other employee of the hospital may be able to access that portion of the patient's medical information. As another example, if the patient gives a particular doctor permission to access a portion of the patient's medical information, the doctor may allow other doctors to access that information for purposes of consultation in the treatment of the patient. Furthermore, the extent to which a permission level 42 provides access to employees, agents, and/or consultants of the grantee may be specifically tailored by the patient and/or the grantee. For example, the patient may tailor the permission level 42 to give access to only the doctor (e.g., no access to employees, etc.). As another example, the patient and/or the hospital may tailor the permission level 42 to give the full access of permission level 42 to medically relevant employees (e.g., doctors, nurses, etc.), billing-level access to billing relevant employees (e.g., accountants), and no access to other employees (e.g., janitors). As a further example, the patient and/or the hospital may tailor the permission level 42 to give the full access of permission level 42 to particular doctors (e.g., doctors currently treating the patient), while giving only partial access of permission level 42 and/or no access to other doctors (e.g., doctors not currently treating the patient).

A permission level 42 may include any level of access of a patient's medical information. Examples of permission level 42 may include full permission (e.g., where the health service provider may have full access to all of the patient's medical information), classification-specific (or health event-specific) permission (e.g., where the health service provider may only have access to medical information associated with a particular classification (or a particular health event) (e.g., “left leg”, “broken bone”, “diabetes”, “psychiatric evaluation”, “dental record”, “check/routine”, “isolated symptom”, “drug related data”, “personal episode”, etc.), type-specific permission (e.g., a radiologist may only have access to medical information classified as an x-ray), provider-specific permission (e.g., a dietician may only have access to medical information associated with the patient's diet and food-related health, an insurance company may only have access to medical information associated with billing, etc.), report-specific permission (e.g., a doctor may only have access to a particular report 38, or particular reports 38), no permission (e.g., which may prevent the health service provider from accessing any medical information about the patient), any other level of access of a patient's medical information, or any combination of the preceding.

A permission level 42 may be expressly given by the patient, or may be implicitly given by the patient. For example, the patient may expressly give a particular health service provider (e.g., a family doctor) full permission to access all of the patient's medical information by signing particular documents at the doctor's office, expressly indicating the permission level 42 to management device 14 (by e-mail, voice message, video, clicking on a permission level button on a graphical user interface window provided by management device 14), any other method of expressly giving permission, or any combination of the preceding. As another example, the patient may implicitly give a permission level 42 by visiting a hospital during an emergency, receiving one or more services from a health service provider, any other method of implicitly giving permission, or any combination of the preceding. Furthermore, a permission level 42 may have a duration for which it is valid. As an example, a patient may give a health service provider a particular permission level 42 that will last for a particular amount of time (e.g., one hour, one day, one week, etc.), or that will last until expressly revoked by the patient. As another example, an implied permission level 42 may only have a duration needed to provide medical services for the patient (e.g., one hour, one day, one week, etc). In such an example, after the duration is over, the permission level 42 may no longer be valid, and the health service provider may not be able to access the patient's medical information.

Network 46 may represent any network operable to facilitate communication between the components of system 10, such as management device 14, communication devices 50, and user device 54. Network 46 may include any interconnecting system capable of transmitting audio, video, signals, data, messages, or any combination of the preceding. Network 46 may include all or a portion of a public switched telephone network (PSTN), a public or private data network, a LAN, a MAN, a WAN, a local, regional, or global communication or computer network, such as the Internet, a wireline or wireless network, an enterprise intranet, or any other communication link, including combinations thereof, operable to facilitate communication between the components.

Communication device 50 may represent any components for communicating one or more clinical packets to management device 14, and may be implemented using any suitable combination of hardware, firmware, and software. Communication device 50 may include a personal computer, a work station, a laptop, a wireless or cellular telephone, an electronic notebook, a tablet, a television, a personal digital system, a fax machine, a digital camera, any other communication device (wireless, wireline, or otherwise) capable of communicating a clinical packet to management device 14, or any combination of the preceding. Communication device 50 may comprise a user interface, such as a display, a microphone, keypad, or other appropriate equipment usable by a user (e.g., a patient, a health service provider, any other type of user), such as a sensor or device used to obtain information from the user and provide it to communication device 50 (e.g., fitness bands, pedometers, thermometers, blood pressure monitors, pulsometers, global positioning system (GPS) tracking systems, activity tracking systems), in order to communicate a clinical packet to management device 14. Furthermore, communication device 50 may also allow a user to communicate any number of clinical packets to management device 14. For example, a health service provider may have their own EMRs stored in their own database. In such an example, the health service provider may utilize communication device 50 to transmit (or connect) their database of records to management device 14. One or more of these records may be communicated as a clinical packet. As such, the health service provider may incorporate their own database of records into management device 14 in a simple and efficient manner.

Communication device 50 may be associated with one or more communication channels. A communication channel may represent a channel used by communication device 50 in order to communicate a clinical packet to management device 14. Examples of communication channels may include e-mail, voicemail, video, fax, cloud services, SMS, MMS, twitter, a social network and/or messaging system (e.g., WHATSAPP, etc.), Bluetooth, near field communications interface, communication via an application (App) installed on a communication device 50, any other communication channel, or any combination of the preceding. As an example, in order to transmit a particular EMR to management device 14, a doctor may use a wireless telephone to take a picture of a prescription written by the doctor, and may text or e-mail the picture as a clinical packet to management device 14. As a further example, the doctor may describe the prescription in a voicemail to management device 14 (which may be transcribed into text). As a further example, the doctor may describe and film the prescription in a video communicated to management device 14 (which may be transcribed into text and/or segmented into individual images of the prescription). As another example, the doctor may fax the prescription to management device 14. Content of the clinical packets communicated by communication device 50 may be text, images, video, audio, any type of document that stores information (text files containing database views, files that contain information coming from any medical device (such as a blood pressure monitor, etc.)), any other content, or any combination of the preceding.

Although FIG. 1 illustrates system 10 as including three communication devices 50 (communication device 50a, communication device 50b, and communication device 50c), system 10 may include any other number of communication devices 50. For example, system 10 may include less than three communication devices 50 (e.g., one or two communication devices 50) or more than three communication devices 50 (e.g., four, ten, 100, 1,000, 10,000, 100,000, 250,000, one million communication devices 50, etc.).

User device 54 may represent any components for displaying information received from management device 14, and may be implemented using any suitable combination of hardware, firmware, and software. User device 54 may include a personal computer, a workstation, a laptop, a wireless or cellular telephone, an electronic notebook, a tablet, a television, a personal digital assistant, or any other device (wireless, wireline, or otherwise) capable of receiving, processing, storing, and/or communicating information with other components of system 10 in order to display information received from management device 14. User device 54 may further allow a user to request information from management device 14 and/or provide information to management device 14. For example, in order to access a particular patient's medical information, a user may provide one or more requests for that medical information to management device 14. As another example, in order to add medical information or update medical information, a user may provide one or more inputs to management device 14. User device 54 may comprise a user interface, such as a display, a microphone, keypad, or other appropriate terminal equipment usable by a user.

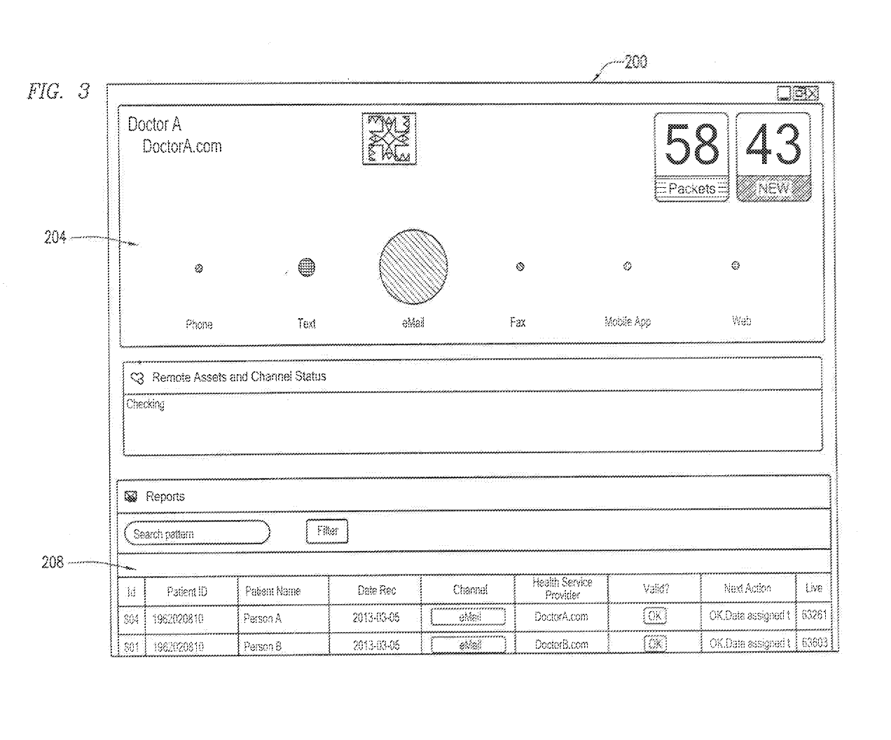

User device 54 may display a graphical user interface 58 in order to allow a user to display the information received from management device 14, request information from management device 14, and/or provide inputs to management device 14. Examples of graphical user interface 58 are discussed further below with regard to FIGS. 3-5.

Although FIG. 1 illustrates system 10 as including only one user device 54, system 10 may include any other number of user devices 54. For example, system 10 may include more than one user device 54 (e.g., four, ten, 100, 1,000, 10,000, 100,000, 250,000, one million user devices 54, etc.). Furthermore, although FIG. 1 illustrates management device 14, communication devices 50, and user device 54 as separate components, two or more of the management device 14, communication devices 50, and user device 54 may be the same component. For example, communication device 50a and user device 54 may be the same device. In such an example, a user may view medical information for a patient at the same device that is used to transmit a clinical packet to management device 14. As another example, user device 54 and management device 14 may be the same device. In such an example, a user may view medical information for a patient at the same device that manages the medical information.

In an example of operations of system 10, in order to develop medical information for a patient, a user may transmit a clinical packet to management device 14 via clinical packet transmission 80. The user may be a patient, a health service provider (e.g., a doctor, a hospital, a medical testing unit, a psychiatrist, a dietician, a personal trainer, a health insurance company, any other provider of health services, or any combination of the preceding), or any other user. The clinical packet may include content associated with the health of the patient. For example, the content may be an EMR provided by a health service provider. In such an example, the content may include any information that may be provided by a health service provider about the patient (e.g., an x-ray, a prescription, a health diagnosis, a recommendation made to the patient, test data, a patient referral, results of a psychiatric exam, notes from an examination of the patient, etc.). Furthermore, in such an example, the clinical packet may be communicated by a health service provider using a communication device 50. As another example, the content may be a PHR provided by the patient. In such an example, the content may include any information that may be provided by the patient about himself (e.g., the patient's family history, a new diet the patient is trying, allergies known to the patient, symptoms of an ailment, information related to previous medical related events (e.g., the patient may provide a scanned copy or a summary of a previous report or test result generated by a health service provider), data obtained by a monitoring sensor or device (e.g., temperature recording, pulse recording, physical constants recording, etc.), any other information that may be provided by the patient, or any combination of the preceding). Furthermore, in such an example, the clinical packet may be communicated by the patient using a communication device 50. An example of a clinical packet is discussed further below with regard to FIG. 2A.

The clinical packet may be communicated by the user via clinical packet transmission 80. Clinical packet transmission 80 may represent any type of transmission that includes one or more clinical packets. Furthermore, clinical packet transmission 80 may be communicated by any communication device 50 over any type of communication channel. For example, clinical packet transmission 80 may occur by e-mail, voicemail, video, fax, cloud services, SMS, MMS, twitter, a social network and/or messaging system, Bluetooth, near field communications interface, communication via an App, any other communication channel, or any combination of the preceding.

Based on the clinical packets received via clinical packet transmissions 80 from communication devices 50, management device 14 may generate one or more reports 38 for one or more patients. A report 38 may represent a report associated with the health of the patient. Furthermore, reports 38 for a particular patient may make up the medical information for that particular patient. An example of a report 38 is discussed further below with regard to FIG. 2B.

Once medical information (e.g., a compilation of reports 38) is generated for a particular patient, a requestor (e.g., the patient, a health service provider, or any other user) may desire to access the medical information for the patient. As such, the requestor may utilize user device 54 to provide a request 84 to management device 14. Request 84 may represent any type of request to access medical information for one or more patients. As an example, if the requestor is the patient, the requestor may provide a request 84 in order to access his own medical information. As another example, if the requestor is a health service provider, the requestor may provide request 84 in order to access medical information for a patient. In such an example, this request 84 may be made so that the health service provider can learn more about the patient before treating the patient, provide additional notes about the patient, refer the patient to another health service provider (e.g., a specialist), any other reason, or any combination of the preceding. Furthermore, access to a patient's medical information may refer to the ability to view a portion of the patient's medical information, update a portion of the patient's medical information, add information to a portion of the patient's medical information, mark a portion of the patient's medical information for deletion or any other type of amendment (although information may be marked for deletion or any other type of amendment, the marked information may still be accessible in its unmarked form or its marked form) any other type of access, or any combination of the preceding.

Request 84 may be communicated to management device 14 in any manner. For example, request 84 may be communicated using one or more of the communication channels (e.g., e-mail, voicemail, video, fax, cloud services, SMS, MMS, twitter, a social network and/or messaging system, Bluetooth, near field communications interface, communication via an App installed on user device 54, any other communication channel, or any combination of the preceding). As another example, request 84 may be communicated using GUI 58 displayed on user device 54. In such an example, a web page associated with management device 14 may be displayed at GUI 58 on user device 54. The user may utilize this GUI 58 to communicate request 84.

After receiving request 84, management device 14 may determine whether to provide the requestor with access to the requested patient's medical information. In order to do so, management device 14 may utilize permission levels 42 for a patient in order to determine whether one or more permission levels 42 have been given to the requestor. For example, if the requestor is the patient's family doctor (who has permission level 42 of full permission), management device 14 may determine that the patient's family doctor has been given full permission to access the patient's medical information. On the other hand, if the requestor is the patient's dietician (who has only been given a permission level 42 for access to medical information regarding the patient's diet and food-related health), management device 14 may determine that the patient's dietician has been given permission to only access medical information regarding the patient's diet and food-related health. As a further example, if the requestor is an unknown doctor or an unknown user (who has not been given any permission level 42 by the user), management device 14 may determine that the requestor has not been given any permission levels 42. In such an example, management device 14 may deny the request (and/or may ask the requestor if the requestor would like to request a permission level 42 from the user). The determination regarding whether to provide the requestor with access to the requested patient's medical information may be based on an identifier associated with the requestor, a log-in by the requestor (e.g., the requestor providing a username and password to log into a GUI associated with management device 14), a code associated with the requestor, any other manner of identifying the requestor and/or the permission level 42 associated with the requestor, or any combination of the preceding. Additionally, while the determination has been discussed above as occurring after the reception of the request 84, the determination regarding whether to provide the requestor with access to particular medical information may occur before or simultaneously with the reception of request 84. For example, a requestor may first log into a GUI associated with the management device 14 (where the log-in may automatically provide the requestor with one or more levels of access to medical information or with access to one or more patient's medical information), and then the requestor may provide request 84 to management device 14. In such an example, the log-in by the requestor may be a permission level 42 and/or may be associated with a permission level 42.

Based on request 84 and permission levels 42, management device 14 may provide medical information transmission 88 to user device 54. Medical information transmission 88 may represent any transmission that includes a portion (or all) of the medical information associated with a patient. For example, if management device 14 determined that the requestor had full permission, medical information transmission 88 may include all of the patient's medical information. As another example, if management device 14 determined that the requestor only had a classification-specific permission, medical information transmission 88 may only include a portion of the patient's medical information (e.g., the portion associated with the classification-specific permission). In such an example, if the patient is visiting a doctor for a checkup on a broken left leg, the doctor may only have a classification-specific permission for “break”, “leg”, and/or “left leg”. As such, the doctor may only be able to access medical information with a classification of “break”, “leg”, and/or “left leg”. The medical information included in medical information transmission 88 may be displayed in any manner. As an example, the medical information may be displayed on GUI 58. Examples of the display of medical information are discussed further below with regard to FIGS. 3-5.

Modifications, additions, or omissions may be made to the system 10 without departing from the scope of the disclosure. The components of the system 10 may be integrated or separated. For example, communication device 50 and user device 54 may be integrated into a single device. Moreover, the operations of the system 10 may be performed by more, fewer, or other components. For example, the operations of management device 14 may be performed by any number of devices. As used in this document, “each” refers to each member of a set or each member of a subset of a set.

FIG. 2A illustrates an example of a clinical packet according to one embodiment of the disclosure. Clinical packet 100 may be communicated to management device 14 via clinical packet transmission 80 of FIG. 1. The communicated clinical packet 100 may be used to generate a report 38 (discussed below). Furthermore, the communicated clinical packet 100 may also be stored by management device 14 (even after it has been used to generate a report 38). As illustrated, clinical packet 100 includes content 104, patient identifier 108, and provider identifier 112.

Content 104 may represent data associated with the health of a patient. For example, content 104 may be an EMR provided by a health service provider. In such an example, the content may include any information that may be provided by a health service provider about the patient (e.g., an x-ray, a prescription, a health diagnosis, a recommendation made to the patient, test data, a patient referral, results of a psychiatric exam, notes from an examination of the patient, physical pictures, video recording, etc.). As another example, content 104 may be a PHR provided by the patient. In such an example, the content may include any information that may be provided by the patient about himself (e.g., the patient's family history, a new diet the patient is trying, allergies known to the patient, symptoms of an ailment, information related to previous medical related events (e.g., the patient may provide a scanned copy or a summary of a previous report or test result generated by a health service provider), data obtained by a monitoring sensor or device (e.g., temperature recording, pulse recording, physical constants recording, etc.), any other information that may be provided by the patient, or any combination of the preceding).

Clinical packet 100 may further include a patient identifier 108 that identifies which patient the content 104 is associated with. Patient identifier 108 may represent any data that may identify a particular patient. As an example, patient identifier 108 may include a number (e.g., 1234567), an alphanumeric code (e.g., 123abc456), a name (e.g., Patient A), any other identifier of a patient, or any combination of the preceding. Patient identifier 108 may be a unique identifier of the patient. For example, although management device 14 of FIG. 1 may store medical information for any number of patients (e.g., one hundred million patients), the patient identifier 108 for a particular patient may only identify that particular patient. Furthermore, although patient identifier 108 may be unique for each patient, the same patient identifier 108 may be used for a particular patient at all times. As such, medical information for a particular patient may not be stored under two or more different patient identifiers 108.

Patient identifier 108 may be generated in any manner. As an example, patient identifier 108 may be generated in a manner that may ensure that patient identifier 108 is unique for each patient and also in a manner that can be replicated by any health service provider (e.g., so that the same patient identifier 108 is used for a patient no matter what health service provider the patient visits). In such an example, patient identifier 108 may be generated based on a date of birth of the patient, a birth order of the patient (e.g., the patient is the first-born child of the patient's mother), the gender of the patient, a name of the patient (e.g., first, last, and/or middle names of the patient), contact information for the patient (e.g., phone number, e-mail address, mailing address, etc.), a password selected by the patient, any other information about the patient, or any combination of the preceding. In particular, in such an example, management device 14 of FIG. 1 may receive the date of birth of the patient, the birth order of the patient, the gender of the patient, the first and last name of the patient, an e-mail address of the patient, a phone number of the patient, and a password selected by the patient, and the management device 14 may change this information into patient identifier 108 based on any suitable rule or algorithm. For example, the management device 14 may change the patient's information into a patient identifier 108 that includes an open numeric portion (based on the date of birth of the patient, the birth order of the patient, and/or the gender of the patient) and an open alphanumeric portion (based on the first and last name of the patient). In such an example, if the patient was born Jan. 1, 2020 (e.g., 01012020), was his mother's first child (e.g., 01), was male (e.g., 0), and had the first name “First” and the last name “Last”, the open numeric portion of the patient identifier 108 may be “010120200101” and the open alphanumeric portion may be “First.Last”. These open portions may be viewable by any person who has access to at least a portion of the patient's medical information. Furthermore, in such an example, the management device 14 may also change the patient's information into a patient identifier 108 that includes a closed portion (based on the e-mail address of the patient, the phone number of the patient, and/or the password selected by the patient). In such an example, if the patient's email address was first.last@email.com, his phone number was (111) 111-1111, and his password was “secret”, the closed portion of the patient identifier 108 may be “first.last@email.com1111111111 secret”. This closed portion may only be viewable by the patient, and therefore, may provide security to the patient's medical information.

As a result of such a patient identifier 108, the health service provider may only need to receive information (such as the information discussed above) about the patient in order to generate a patient identifier 108 for the patient. Furthermore, because the patient identifier 108 is based on information about the patient, himself (as opposed to an identification system that is unique to each health service provider), any health service provider 108 may generate (or otherwise access) the same patient identifier 108 for the patient.

Although clinical packet 100 is described above as including a patient identifier 108, clinical packet 100 may not always include a patient identifier 108. For example, a clinical packet 100 may be an “orphan” packet that does not include a patient identifier 108. Such an orphan packet may be the result of the patient and/or a health service provider sending the clinical packet 100 without identifying the patient identifier 108 (or without knowing the patient identifier 108). In such an example, management device 14 may parse (described below) the clinical packet 100 in order to determine the unknown patient identifier 108. In particular, the parsing of the clinical packet 100 may extract a name mentioned in content 104, and the name may be compared to names of known patients. If a match occurs, the orphan packet may be identified as belonging to the matched patient.

As is discussed above, a clinical packet (such as clinical packet 100) may be transmitted to management device 14 by a health service provider. In order to transmit the clinical packet 100, the health service provider may determine a patient's patient identifier 108 in any manner. For example, the health service provider may generate the patient identifier 108 (or access management device 14 to generate the patient identifier 108) using information provided by the patient. As another example, the health service provider may retrieve the patient identifier 108 from their records. As a further example, the patient may provide the patient identifier 108 to the health service provider. In such an example, the patient may inform the health service provider that his patient identifier 108 is, for example, 123abc456. However, due to the potential length of a patient identifier 108, the patient identifier 108 may also be converted into a code (e.g., by management device 14 and in any suitable manner) that may be more easily used by the patient, such as a bar code or a Quick Response (QR) code. As such, the code may be included on an identification card that may be provided by the patient to the health service provider (which may scan or otherwise enter the code). Furthermore, the patient identifier 108 may also be associated with one or more biometrics of the patient, such as a fingerprint, retinal scan, voice pattern, blood analysis, Deoxyribonucleic acid (DNA) analysis, and/or any other biometric. As such, the health service provider may scan the patient's biometrics in order to determine the patient identifier 108. Accordingly, the health service provider may include the patient identifier 108 in a clinical packet 100.

Clinical packet 100 may further include a provider identifier 112 that identifies which health service provider the content 104 is associated with. As an example, provider identifier 112 may identify the health servicer provider that created content 104, communicated clinical packet 100 to management device 14, and/or signed off on the information in clinical packet 100. Provider identifier 112 may represent any data that may identify a health service provider. As an example, provider identifier 112 may include a number, an alphanumeric code, a name, or any other data that identifies a health service provider. Furthermore, provider identifier 112 may be generated in the same manner as patient identifier 108. Additionally, although clinical packet 100 is described as including a provider identifier 112, clinical packet 100 may not always include a provider identifier 112. For example, clinical packet 100 may be provided by a health service provider or the patient. When the clinical packet 100 is provided by the health service provider, the clinical packet may include provider identifier 112, as is illustrated in FIG. 2A. However, when the clinical packet 100 is provided by the patient himself, clinical packet 100 may not include a provider identifier 112. Such a lack of the provider identifier 112 in the clinical packet 100 may be the result of a health service provider not being involved in the generation and/or communication of clinical packet 100.

Modifications, additions, or omissions may be made to clinical packet 100 without departing from the scope of the disclosure. For example, although clinical packet 100 is illustrated as including particular information, clinical packet 100 may include more or less information. As an example of this, clinical packet 100 may include information that may identify one or more dates and/or times associated with the clinical packet. For example, clinical packet 100 may include information that may identify the date and time the content 104 was generated and/or the date and time clinical packet 100 was communicated to (and/or received by) management device 14.

FIG. 2B illustrates an example of a report according to one embodiment of the disclosure. Report 38 may be generated and stored by management device 14 of FIG. 1. Furthermore, report 38 may be generated based on clinical packet 100 of FIG. 2A. As is illustrated, report 38 includes report identifier 140, patient identifier 108, provider identifier 112, date/time 144, content 104, classifications 148, and types 152. Patient identifier 108, provider identifier 112, and content 104 of FIG. 2B may be similar to patient identifier 108, provider identifier 112, and content 104 of FIG. 2A. Furthermore, although patient identifier 108, provider identifier 112, and content 104 of FIG. 2B may be similar to patient identifier 108, provider identifier 112, and content 104 of FIG. 2A, patient identifier 108, provider 112, and/or content 104 of FIG. 2B may be stored differently in report 38 than it is stored in clinical packet 100. For example, patient identifier 108 may be stored in segments (a first segment for the open numeric portion, a second segment for the open alphanumeric portion, and a third segment for the closed portion).

Report identifier 140 may represent any data that may identify a particular report. For example, report identifier 140 may include a number, an alphanumeric code, a name, an md5_file( ) code, or any other data that identifies a report 38. By identifying a report 38 using report identifier 140, all of the information (patient identifier 108, provider identifier 112, date/time 144, content 104, classifications 148, types 152) may be associated with the report identifier 140 and the report 38. As such all the information may be stored together and/or in a manner that allows all the information for a report 38 to be retrieved. Furthermore, when the report identifier 140 for a particular report 38 is determined to be part of medical information that may be communicated for display to a requestor, all of the information associated with report identifier 140 and report 38 may be communicated for display also.

Date/time 144 may represent any data that may identify the date and/or time associated with content 104. For example, if content 104 (e.g., an x-ray) is created by a health service provider on Jan. 15, 2014 at 1:15 p.m. CDT, the date/time 144 may be data that identifies that particular date and time. As such, a user may be able to understand when content 104 was generated. Furthermore, date/time 144 may further allow medical information for a patient to be communicated for display as a timeline. Date/time 144 may also be data that identifies any other particular date and time associated with content 104. For example, date/time 144 may identify the date and time clinical packet 100 was communicated to management device 14, the date and time clinical packet 100 was used to generate report 38, the date and time report 38 was approved by the doctor who communicated it (e.g., a doctor may check to see that report 38 was generated correctly), and/or any other date and time. Furthermore, date/time 144 may include more than one date/time. For example, the date/time 144 may be data that identifies multiple dates (e.g., the date and time the content 104 was generated, the date and time clinical packet 100 was communicated to (and/or received by) management device 14, the date and time clinical packet 100 was used to generate report 38, and the date and time report 38 was approved by the doctor who communicated it).

Classification 148 may represent any data that may identify a medical classification of content 104. As an example, classification 148 may include data associated with a diagnosis in content 104. In such an example, if content 104 includes an x-ray of a patient's broken left leg, classification 148 may include data associated with that x-ray, such as “personal episode”, “leg”, “left leg”, “broken left leg”, “broken tibia of left leg”, any other suitable classification of the x-ray, or any combination of the preceding. Classification 148 may include one or more grouping classifications which may provide an indication of the importance of the content 104 and/or the reason the content 104 was generated. Grouping classifications may include “check/routine”, “isolated symptom”, “drug related data”, “personal episode” (or “personal health event”), any other grouping classification, or any combination of the preceding. The “check/routine” grouping classification may represent a diagnosis in content 104 associated with a standard/routine medical check (e.g., annual physical of a patient, blood pressure test, glucose test, etc.). The “isolated symptom” grouping classification may represent a diagnosis in content 104 associated with an incident that the patient is not overly concerned about (e.g., a new diet the patient is trying, a slight fever reported by the patient without going to a doctor, a new workout regime, etc.). The “drug related data” grouping classification may represent a diagnosis in content 104 associated with prescriptions, medications, and/or drugs that are being prescribed to the patient and/or that are currently being taken by the patient (e.g., blood pressure medication, acne medication, etc.). The “personal episode” grouping classification (or the “personal health event” grouping classification) may represent a diagnosis in content 104 associated with an important incident (e.g., a broken leg, chronic knee problems, severe headaches, dehydration, etc.).

Classification 148 may also include (or may alternatively include) one or more descriptive classifications which may provide a description of the diagnosis and/or the content 104. Examples of descriptive classifications may include “leg”, “left leg”, “broken left leg”, “broken tibia of left leg”, “headache”, “migraine”, “cavity”, “dislocation”, any other description of a diagnosis and/or the content 104, or any combination of the preceding. Descriptive classifications may be a subset of grouping classifications. For example, when a patient breaks his leg, the grouping classification may be “personal episode” and the descriptive classifications of “leg”, “left leg”, “broken left leg” may be subsets of the “personal episode”.

Classification 148 may assist a health service provider and/or a patient in understanding what is in content 104 of report 38. For example, the health service provider and/or the patient may be able to look at the classification 148 in order to determine that the patient had an important incident where he broke his left leg (as opposed to reviewing the content 104, itself). As such, if a health service provider is looking for any reports 38 associated with a patient's diabetes, the health service provider may be able to skip over reports 38 that include a classification 148 of “broken left leg”. Classification 148 may also allow health service provider and/or patient to filter and/or search for a particular report 38 (e.g., when the health service provider and/or patient only wants to view reports 38 associated with the patient's “left leg” or “broken left leg”). Classification 148 may also be related to permission levels 42 of FIG. 1, such as classification-specific permission. As an example, if a patient is going to visit a health service provider to have a check up on their healing broken left leg, the patient may give the health service provider a classification-based permission that grants the health service provider access to only reports 38 that include classifications 148 for “leg”, “left leg”, “broken left leg”, “break”, or any combination of the preceding. As such, the health service provide may only be able to access reports 38 that include one or more of these classifications. Furthermore, each report 38 may include any number of classifications 148. For example, an x-ray of a patient's broken left leg may include three classifications 148, such as “personal episode”, “leg”, and “broken left leg”.

Classification 148 may be determined by management device 14. Furthermore, classification 148 may be determined in any suitable manner. For example, classification 148 may be determined by management device 14 based on content 104. An example of such a determination is disclosed below.

First, management device 14 may generate data associated with content 104 by converting content 104 into machine-encoded text. For example, management device 14 may utilize optical character recognition (OCR) in order scan content 104 and convert the scanned content into machine-encoded text. In such an example, OCR technology may be utilized to convert an x-ray (which may include one or more identifiers, such as “left leg”, “1/15/2015” “Doctor B”, “Patient A”) into text (e.g., “left leg 1/15/2015 Doctor B Patient A”) as data associated with content 104. Management device 14 may utilize any type of OCR program for converting content 104 into machine-encoded text, such as OMNIPAGE Standard, PRESTO! OCR, Readiris Pro, ABBYY PDF TRANSFORMER, Tesseract, or any other OCR program.

Second, once this data associated with content 104 is generated, management device 114 may parse the data. Parsing may represent a process of analyzing a string of symbols according to rules of formal grammar, as well as image matching or raw image comparison and analysis. As an example, management device 14 may parse the data associated with the content 104 (e.g., “left leg 1/15/2015 Doctor B Patient A”) in order to determine that content 104 is associated with “left leg”, “1/15/2015”, “Doctor B”, and “Patient A” Management device 14 may utilize any type of parsing program to parse the data, such as ANTLR, Bison, Coco/R, GOLD, or any other parsing program.

Third, based on this parsing, management device 14 may determine one or more classifications 148 for the content. As an example, management device 14 may determine the classifications 148 (and types 152, as is discussed below) by making inferences based on the parsed data. In such an example, management device 14 may determine that the content is a “personal episode” based on the fact that the patient was treated by “Doctor B” for the incident (e.g., the fact that the patient went to a doctor for treatment infers that the incident was important). Furthermore, management device 14 may determine that the content is a “check/routine” based on comparing the parsed term “physical” in the content to terms that are attributable to standard/routine checks, may determine that the content is an “isolated symptom” based on the fact that the clinical packet 100 was sent by the patient and did not include a provider identifier 112 or the name of a doctor in the parsed data, and/or may determine that the content is “drug related data” based on the fact that the parsed data includes the term “prescription” and the name of a particular type of drug (e.g., blood pressure medication).

As another example, management device 14 may determine the classifications 148 by matching current classifications 148 to the parsed data. In such an example, management device 14 may match the parsed data of “left leg” to one or more current classifications 148 of “leg” and “left leg”. Based on such a match, management device 14 may determine these classifications 148 and associate them with content 104 and report 38. As a further example, management device 14 may generate new classifications 148 based on the parsed data. For example, if the parsed data of “left leg” does not match any current classifications 148, management device 14 may generate a new classification 148, such as “left leg” and/or “leg”. As such, management device 14 may determine one or more classifications 148 for content 104.

Furthermore, in addition to management device 14 using parsing to determine one or more classifications 148 for the content 104 (and one or more types 152 for the content 104, as is discussed below) the parsing may also allow one or more portions of the content 104 to be translated. As an example, the parsing of content 104 may result in particular terms being found in content 104, such as the medical term “type II uncontrolled diabetes”. These terms may be matched to a database of terms and/or identifiers, such as the International Classification of Diseases (ICD). For example, the medical term “type II uncontrolled diabetes” may be matched to the ICD code 250.02. Additionally, this code may be matched to a database of foreign language translations of the code (e.g., a thesaurus) to provide a translation of the medical term. As such, if a Spanish-speaking health service provider accesses the report 38, the Spanish-speaking health service provider may understand that the patient has been diagnosed with type II uncontrolled diabetes even though that diagnosis was in content 104 written in the English language.

Type 152 may represent any data that may identify a type of content 104. For example, type 152 may be a medical identifier of the content 104. In such an example, if the content 104 is an x-ray, the type 152 of the content 104 may be “x-ray”. Furthermore, if the content 104 is a physician's notes, the type may be “physician notes”. Additionally, if the content 104 if a blood test, the type may be “blood test”. Examples of type 152 may further include: “imaging test”, “lab test”, “urine test”, “genetic profile”, “echography Ob/Gyn”, “echography abdominal”, “echocardiography”, “magnetic resonance imaging” (MRI), “positron emission tomography”, “emergency report”, “outpatient visit report”, “discharge report”, “continuity report”, “medical certificate”, any other medical identifier of the content 104, or any combination of the preceding. Furthermore, because types 152 may represent any data that may identify a type of content 104, types 152 may be referred to as content types.

Similar to classifications 148, types 152 may assist a health service provider and/or a patient in understanding what is in content 104 of report 38. Furthermore, types 152 may also allow health service provider and/or patient to filter and/or search for a particular report 38. Additionally, each report 38 may include any number of types 152.

Type 152 may be determined by management device 14. Furthermore, type 152 may be determined in any suitable manner. For example, type 152 may be determined by management device 14 based on content 104. In such an example, type 152 may be determined in a manner similar to classification 148. Furthermore, in such an example, type 152 may also be determined (or may be alternatively determined) based on image matching or raw image comparison and analysis. For example, images included in content 104 (e.g., MRI scans, x-rays, prescriptions) may be compared to known images. In such an example, if the images in content 104 match the known images (e.g., the MRI scan matches a known image of an MRI scan), the type 152 may be determined to be the same as the matched image (e.g., MRI).

Although classifications 148 and types 152 have been described above as being determined automatically by management device 14, classifications 148 and types 152 may also be input by a user. For example, a health service provider may further be able to add and/or change classifications 148 and/or types 152. In such an example, a health service provider may transmit a clinical packet 100 including content 104 that is an x-ray of the patient's left leg. If the health service provider later accesses that report 38, and sees that the report 38 includes a classification 148 of only “left leg”, the health service provider may add a classification 148 of “break” and/or “broken left leg”. As another example, if the health service provider sees that the classification 148 includes “leg”, the health service provider may reclassify classification 148 to be “left leg”. As a further example, the health service provider may add the classification 148 and/or type 152 prior to the generation of the report 38. In such an example, the health service provider may include the classification 148 with the clinical packet 100 before it is sent to management device 14 or may add the classification 148 to the clinical packet 100 after it is received by management device 14 but before the clinical packet 100 is parsed to generate report 38.

Modifications, additions, or omissions may be made to report 38 without departing from the scope of the disclosure. For example, although report 38 has been described above as being generated based on a clinical packet (e.g., clinical packet 100 of FIG. 2A), report 38 may be generated based on more than one clinical packet, such as two clinical packets, three clinical packets, or any other number of clinical packets (e.g., report 38 may be generated based on two or more different clinical packets all including a particular classification 148, such as “broken left leg”), or report 38 may be generated based on only a portion of a clinical packet (e.g., a single clinical packet associated with both a physical exam and also the prescription of a medication during the same visit with a health service provider may be used to generate two or more reports 38). As another example, although report 38 has been described as including particular information, report 38 may include more, less, or different information. As an example of this, report 38 may include one or more of the following information in addition to (or as an alternative to) one or more of report identifier 140, patient identifier 108, provider identifier 112, date/time 144, content 104, classifications 148, and types 152 of report 38:
Id—an internal identifier used to handle the relationship between various tables that store information regarding patients, classifications 148, and types 152
IdUsu—an identifier of the patient, such as patient identifier 108
IdPin—an identifier of clinical packet 100
NumImages—the number of images in content 104
RawImage—the name of the first image file in content 104
RawImage2—the name of the second image file in content 104
RawImage3—the name of the third image file in content 104
Fecha—the date and/or time when report 38 was generated (using clinical packet 100) and/or stored
FechaInput—the date and/or time when content 104 was created by a health service provider or anther user
EvRuPunt—a flag associated with the grouping classifications (e.g., 0=“personal episode”, 1=“check/routine”, 2=“isolated symptom”, 3=“drug related data”). One or more of the flags may have pointers to other classifications 148, such as descriptive classifications such as “leg”
Evento—a pointer to other classifications 148. For example, a “personal episode” may have a pointer to descriptive classifications such as “leg”, “left leg”, “broken left leg”
Tipo—a pointer to types 152 of report 38
Especialidad—a pointer to a medical specialty associated with report 38 and/or content 104 (e.g., surgery, neurology)
EspecialidadT—a second pointer to a medical specialty associated with report 38 and/or content 104 (e.g., surgery, neurology)
ICD—an ICD code associated with report 38 and/or content 104
TextoRel—raw OCR'd text from content 104 (prior to parsing)
confirmcode—a cryptographic hash code (e.g., 128 bit) used to isolate and identify every report 38 and/or clinical packet 100 until confirmed by the patient and/or the health service provider
approved—a flag associated with the approval of the report 38 and/or clinical packet 100 (e.g., the flag is set to 1 if the report 38 and/or clinical packet 100 is verified and confirmed by the patient and/or the health service provider)
CENTRO—the hospital or other health service provider that produced the clinical packet 100 (if any)
EMAILORIGEN—the e-mail used to communicate the clinical packet 100 (if any)
CANAL—the channel used to communicate the clinical packet 100
NeedACTION—a flag used to identify whether report 38 needs a further action
IdEmail—an identifier associated with the e-mail used to communicate the clinical packet 100 (if any)
FechaEmail—the date and/or time that the e-mail with the clinical packet 100 was sent and/or delivered (if any)
IdUsFIXED—the open numeric portion of the patient identifier 108
IdUsFIXEDNAME—the open alphanumeric portion of the patient identifier 108
IdUsRESERV—the closed portion of the patient identifier 108 (reserved for the patient)
IdMEDEmail—the e-mail of the health service provider associated with content 104 (if any)
IdMedRESERV—a reserved code (e.g., specific word) for the health service provider associated with content 104 (if available)
SignedUSER—identifier of the user (e.g., patient, health service provider) that verified and confirmed the report 38 and/or clinical packet 100 (if any)
IdMed—identifier of the health service provider associated with the content 104 (if any)
CreatorType—an identifier associated with the type of the creator of content 104 and/or clinical packet 100 (e.g., a flag set to 1 if the creator is a health service provider, or set to NULL if the creator is a patient)
IdCreator—a pointer to the identity of the creator
SignedUSERDate—the date and/or time that the user verified and confirmed the report 38 and/or clinical packet 100 (if any)
ValidationStatus—a flag to a type of validation (e.g., 1=Cancelled; 0=VALID; 1=Not a Valid patient identifier 108; 2=health service provider not Present; 3=awaiting user id; 4=Waiting for user confirmation; 8=Content Secured; 99=Not Parsed)
NextAction—a flag to indicate the next suggested action (e.g., 1: Confirm with health service provider, 2: Confirm with Patient. NULL: no specific action suggested)
Location—a flag to indicate what server, computing device, and/or management device 14 first received the clinical packet 100

FIG. 3 illustrates an example of a graphical user interface according to one embodiment of the disclosure. Graphical user interface 200 may be an example of a graphical user interface communicated for display on graphical user interface 58 of user device 54 of FIG. 1. As illustrated, graphical user interface 200 includes communication channel usage 204 and list of reports 208.

Communication channel usage 204 may represent the usage by the health service provider of particular communication channels in order to transmit clinical packets 100 to management device 14 via clinical packet transmission 80. As illustrated, communication channel usage 204 may identify particular channels utilized by the health service provider (e.g., phone, text, e-mail, fax, mobile app, web) and may further identify how many times those particular communication channels have been utilized. For example, communication channel usage 204 may identify that the e-mail communication channel has been used for 30 of 58 clinical packets 100 and may further identify that the text communication channel has been used for 10 of 58 clinical packets 100. Communication channel usage 204 may identify any number of communication channels. Furthermore, communication channel usage 204 may identify how many times those particular communication channels have been utilized in any manner. For example, communication channel usage 204 may provide a number of uses of a communication channel (e.g., the e-mail communication channel was used for 30 of 58 clinical packets 100), a percentage of the number of uses of a communication channel (e.g., the e-mail communication channel has been used for 51.7% of the clinical packets 100), a symbol of the number of uses of the communication channel (e.g., a symbol, such as a circle, that enlarges as the communications channel is used more), any other manner of identifying how many times a communication channel has been utilized, or any combination of the preceding.

List of reports 208 may represent a list of reports for the health service provider. For example, list of reports 208 may include reports 38 generated based on clinical packets 100 communicated by the health service provider, reports 38 transmitted to the health service provider as a referral, any other report 38, or any combination of the preceding. List of reports 208 may allow the health service provider to click on (or otherwise select) and view each report 38 in order to understand what reports 38 the health service provider may be responsible for. As an example, list of reports 208 may allow a health service provider to add and/or change a classification 148 for a particular report 38.

Modifications, additions, or omissions may be made to graphical user interface 200 without departing from the scope of the disclosure. For example, although graphical user interface 200 has been described as including particular information, graphical user interface 200 may include more or less information.

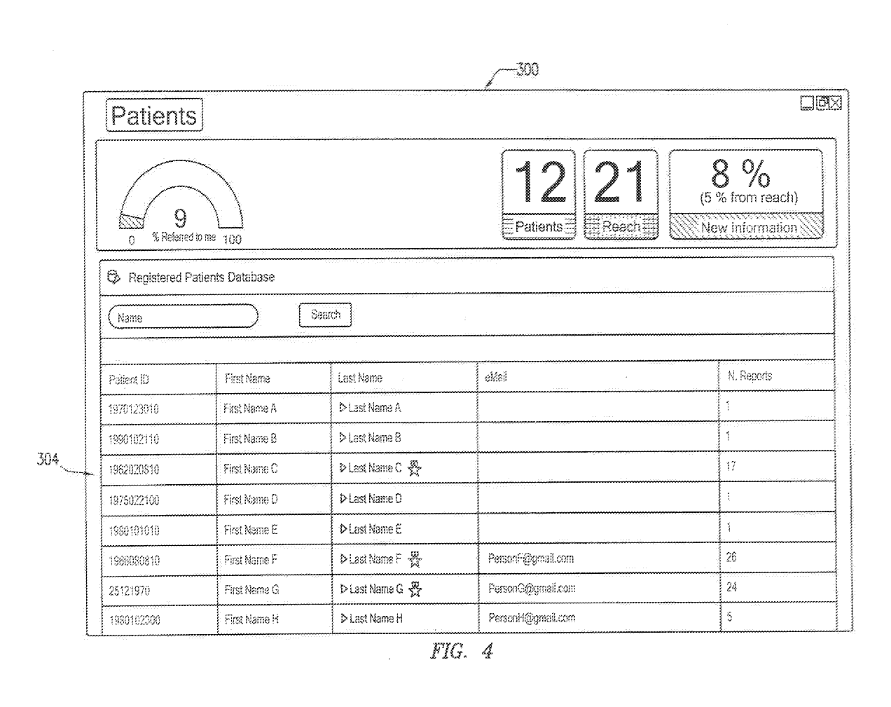

FIG. 4 illustrates another example of a graphical user interface according to one embodiment of the disclosure. Graphical user interface 300 may be another example of a graphical user interface communicated for display on graphical user interface 58 of user device 54 of FIG. 1. As illustrated, graphical user interface 300 includes list of patients 304.

List of patients 304 may represent a list of patients of the health service provider. For example, list of patients 304 may include patients that have been treated by the health service provider, that are scheduled to be treated by the health service provider, that may have been referred to the health service provider, any other patient, or any combination of the preceding. The health service provider may utilize list of patients 304 in order to select a particular patient and view medical information associated with that particular patient. For example, by clicking on (or otherwise selecting) a particular patient in list of patients 304, health service provider may provide request 84 of FIG. 1 to management device 14. Based on this request 84, management device 14 may determine whether the health service provider has one or more permission levels 42 associated with the patient. If so, management device 14 may provide at least a portion of the medical information to the health service provider. On the other hand, if the health service provider does not have a permission level 42 associated with the patient (e.g., when the patient has been referred to the health service provider but the patient has yet to provide any permission levels 42 to the health service provider), management device 14 may deny the request 84 by the health service provider. Additionally, management device 14 may also provide health service provider an opportunity to request a permission level 42 from the particular patient. If the health service provider requests a permission level 42, management device 14 may correspond with the patient (e.g., by e-mail, voicemail, etc.) in order to attempt to receive the permission level 42 for the health service provider. When the patient does grant the permission level 42 (or decides not to grant the permission level 42), management device 14 may provide the appropriate response to the health service provider (e.g., providing the health service provider with access to the medical information of the patient, or informing the health service provider that the permission level request was denied).

Modifications, additions, or omissions may be made to graphical user interface 300 without departing from the scope of the disclosure. For example, although graphical user interface 300 has been described as including particular information, graphical user interface 300 may include more or less information.

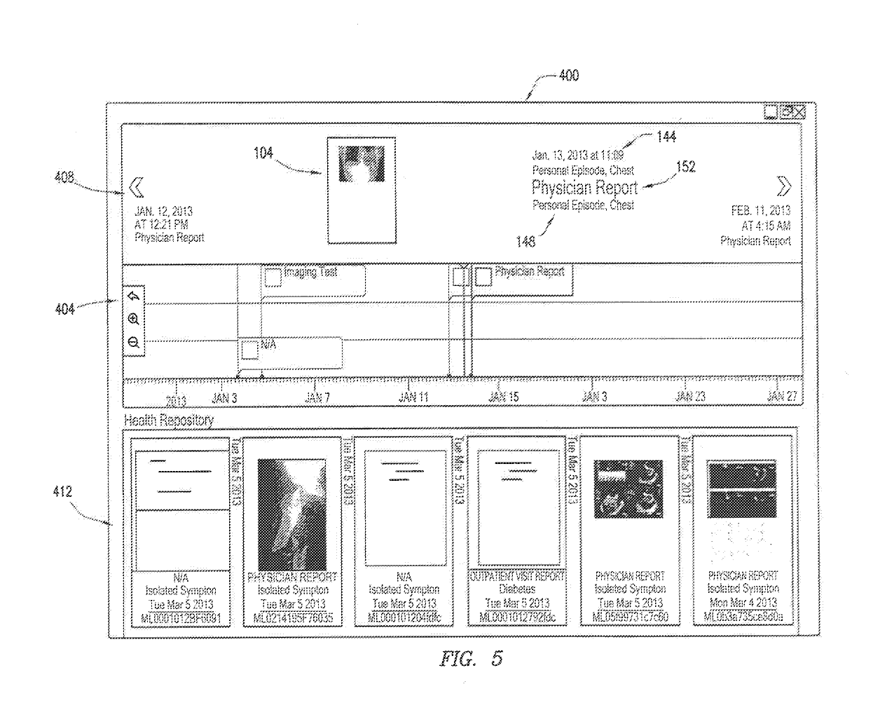

FIG. 5 illustrates another example of a graphical user interface according to one embodiment of the disclosure. Graphical user interface 400 may be another example of a graphical user interface communicated for display on graphical user interface 58 of user device 54 of FIG. 1. As illustrated, graphical user interface 400 includes timeline 404, current report data 408, and repository health data 412.

Timeline 404 represents an illustration of a timeline of medical information for the patient. For example, timeline 404 may provide each report 38 for the patient in timeline-order based on the date/time of report 38. As such, a health service provider may be able to scroll through the patient's timeline 404 and view how the patient's health has progressed from the beginning of the timeline 404 to the end. Timeline 404 may include an indicator for each report 38 associated with the patient. For example, if the patient has a report 38 associated with Jan. 3, 2014 and a report 38 associated with Jan. 12, 2014, timeline 404 may include indicators for each of those reports 38. As such, the health service provider may be able to scroll through the timeline 404 and select particular reports 38 for further view. Although timeline 404 is illustrated as including all of the reports 38 for a particular patient, if the health service provider does not have a permission level 42 for particular reports 38, those reports 38 may not be displayed on timeline 404 (or those reports 38 may be displayed on timeline 404 as “blinded reports,” thereby allowing the health service provider to request permission from the patient to access those reports 38).

Current report data 408 may represent an illustration of one or more pieces of information included in a report 38 selected by the health service provider in timeline 404. For example, as illustrated, current report 408 includes content 104, date/time 144, classifications 148 (e.g., “personal episode”, “chest”), and type 152 (e.g., “physician report”). Current report data 408 may efficiently summarize the information of report 38 and may further provide content 104 for view by the health service provider. When content 104 is clicked on (or otherwise selected), an enlarged view of content 104 may be displayed (not shown). The enlarged view of content 104 may allow the health service provider to view content 104 in detail, and may further allow the health service provider to zoom in (or zoom out) on particular portions of content 104. Furthermore, if content 104 is multiple pages, the enlarged view may allow the health service provider to view each of the pages.

Repository health data 412 may represent a list of reports 38 for view by the health service provider. Repository health data 412 may illustrate reports 38 in a different order than timeline 404. For example, while timeline 404 may list each report 38 in timeline-order based on the date/time, health repository 412 may list reports 38 (e.g., by providing images of reports 38) in any other order (e.g., order of importance, order of frequency of viewing, etc.). This may allow the health service provider to understand medical information associated with the patient without scrolling through the timeline 404. Each of the reports 38 in repository health data 412 may be clicked on (or otherwise selected) in order to display an enlarged view of content 104 and one or more of the other items in report 38 (e.g., classifications 148, types 152, etc.). Repository health data 412 may further include “blinded reports” that the health service provider does not have permission to access. These “blinded reports” may be clicked on (or otherwise selected) in order for the health service provider to request permission from the patient to access the blinded reports.

Modifications, additions, or omissions may be made to graphical user interface 400 without departing from the scope of the disclosure. For example, although graphical user interface 400 has been described as including particular information, graphical user interface 400 may include more or less information. For example, graphical user interface 400 may include any other information regarding the patient. In such an example, graphical user interface 400 may include demographic information for the patient (e.g., date of birth, gender, biometric data (e.g., height, weight, etc.), prescription-based data (e.g., what prescriptions the patient is currently on or previously on, etc.), allergy data (e.g., what the patient is allergic to, etc.), any other data regarding the patient, or any combination of the preceding).

FIG. 6 illustrates a method for management of medical information according to one embodiment of the disclosure. One or more steps of method 500 may be performed by management device 14. For example, one or more steps of method 500 may be performed in accordance with the description of one or more of FIGS. 1-5.

The method 500 begins at step 505. At step 510, one or more clinical packets are received. The clinical packet may be received from one or more communication devices 50 of FIG. 1 over one or more communication channels (e.g., e-mail, voicemail, video, fax, cloud services, SMS, MMS, etc.). Furthermore, the clinical packet may be received from any type of user (e.g., a patient, a health service provider, any other type of user) of communication device 50. The clinical packet may be clinical packet 100 of FIG. 2A. As such, the clinical packet may include content 104, patient identifier 108, and/or provider identifier 112. Any number of clinical packets may be received at step 510, and the clinical packets received at step 510 may be associated with any number of patients.

At step 515, a clinical packet is selected. Any of the clinical packets may be selected, and the clinical packets may be selected in any suitable manner. Once the clinical packet is selected at step 515, one or more steps of method 500 (such as steps 520-540 of method 500) may be performed for that particular selected clinical packet.

At step 520, data of the clinical packet is parsed. For example, the content (such as content 104) in the clinical packet may be converted into text, and the text may be parsed in order to analyze the text. In such an example, an x-ray may be OCR'd and parsed in order to determine the text “left leg”.

At step 525, one or more classifications may be determined. The classification may be classification 148 of FIG. 2B. The classification may be determined for the content included in the clinical packet. For example, based on the parsing of an x-ray of a broken leg, the classification “personal episode”, “leg”, “left leg”, and/or “broken left leg” may be determined.

At step 530, one or more types are determined. The type may be type 152 of FIG. 2B, and may be referred to as a content type. The type may be determined for the content included in the clinical packet. For example, based on the parsing of an x-ray of a broken leg, the type “x-ray” may be determined.

At step 535, the classifications and types are associated with the content. For example, the classifications and types may be associated with the content included in a report identifier (such as report identifier 140 of FIG. 2B). As such, the classifications, types, and content may be associated with a particular report 38.

At step 540, the content, classifications, and types are stored as medical information. For example, the content, classifications, and types (which may be associated with a particular report 38) may be stored as medical information for the patient to which the report 38 belongs. Such medical information may include each report 38 generated by management device 14 for that patient. As such, medical information may be generated for the patient.

At step 545, it is determined whether there are any other clinical packets for which classification and types have not been determined. If there are additional clinical packets, method 500 may move back to step 515 where a clinical packet is selected. As such, steps 515-540 of method 500 may be repeated for each clinical packet. On the other hand, if there are not any other clinical packets, the method 500 may move to step 550.

At step 550, a request to view medical information is received. The request to view medical information may include a request to view medical information for a particular patient, and may be received from any requestor (e.g., the patient, a health service provider, any other type of requestor). The request to view medical information may be received from a user device 54 of FIG. 1. Furthermore, the request may be transmitted to management device 14 using graphical user interface 58 of user device 54 (or using any other communication channel). As an example, the request may be transmitted by the health service provider selecting a particular patient in a graphical user interface, such as graphical user interface 300 of FIG. 4.

At step 555, it is determined whether the requestor has a permission level for the patient. The permission level may be a permission level 42 of FIG. 1. If the requestor does not have a permission level for the patient (or, for example, the requestor has a permission level of no permission), the method may move to step 565, where method 500 ends. On the other hand, if the requestor does have a permission level (or, for example, has a permission level other than no permission) for the patient, the method may move to step 560.

At step 560, medical information is communicated for display. The medical information communicated for display may include any portion of the medical information for a patient. For example, the portions of the medical information that are communicated for display may be based on the permission levels that have been given to the health service provider. In such an example, if the health service provider has been given full permission, all of the medical information of the patient may be communicated for display to the health service provider. On the other hand, if the health service provider has only been given a classification-specific permission, only reports 38 that include a classification (such as classification 148) that matches the classification-specific permission may be communicated for display to the health service provider.

The medical information may be communicated to the requestor as any type of display. As an example, the medical information may be communicated for display as a timeline, such as is illustrated in graphical user interface 400 of FIG. 5. Once the medical information has been communicated for display, the method may move to step 565, where the method ends.

The steps illustrated in FIG. 6 may be combined, modified, or deleted where appropriate. Additionally, the described steps may be performed in any order. For example, a request for medical information may be received before a classification and type has been determined for every clinical packet. As another example, a request for medical information may be received after or simultaneously with the determination regarding whether the requestor has a permission level for a particular patient. In such an example, the requestor may log-in to a GUI associated with the management device, and such a log-in may automatically provide the requestor with one or more levels of access to medical information or with access to one or more patient's medical information. The requestor may then request access to particular medical information. Furthermore, additional steps may also be added to the example operation. As a first example, if the requester does not have a permission level at step 555, method 500 may not end. In such an example, the method may further include steps where a request to receive a particular permission level from a patient is received (e.g., the requestor clicks on (or otherwise selects) a “blinded report”). Following such a request, management device 14 may correspond with the patient (e.g., by e-mail, voicemail, etc.) to ask whether the patient will give the requested permission level. Based on this, management device 14 may determine whether the patient has given the requested permission level. If the patient has given the requestor the particular permission level, management device 14 may communicate for display the medical information to the requestor. As a second example, if a clinical packet is received at step 510 from a health service provider, the method may further include steps where the patient is informed of the clinical packet. In such an example, management device 14 may determine (based on the clinical packet) the patient identifier 108 included in the clinical packet, and may send a confirmation (e.g., by e-mail, voicemail, etc.) of the clinical packet to the patient associated with the patient identifier 108.

Although the present disclosure has been described with several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims.

What is claimed is:

1. A system, comprising:
a memory;
one or more processors communicatively coupled to the memory and operable to:
receive one or more clinical packets, each clinical packet comprising content associated with the health of one of a plurality of individuals;
for each of the received clinical packets, store, in the memory, the content as medical information for the associated one of the plurality of individuals;
receive, from a first requestor, a first request to view the medical information associated with a first individual;
following the first request, determine a first one or more portions of the medical information of the first individual, the first one or more portions of the medical information being associated with one or more permission levels given to the first requestor by the first individual;
following the determination of the first one or more portions of the medical information of the first individual, communicate for display the first one or more portions of the medical information of the first individual;
receive, from a second requestor, a second request to view the medical information associated with the first individual;
following the second request, determine a second one or more portions of the medical information of the first individual, the second one or more portions of the medical information being associated with one or more permission levels given to the second requestor by the first individual, the second one or more portions of the medical information being at least partially different from the first one or more portions of the medical information; and
following the determination of the second one or more portions of the medical information of the first individual, communicate for display the second one or more portions of the medical information of the first individual.

2. The system of claim 1, wherein the one or more processors are further operable to:
receive, from a third requestor, a third request to view the medical information associated with the first individual; and
following the third request, determine a third one or more portions of the medical information of the first individual, the third one or more portions of the medical information being associated with one or more permission levels given to the third requestor by the first individual, the third one or more portions of the medical information being at least partially different from the first one or more portions of the medical information and the second one or more portions of the medical information; and
following the determination of the third one or more portions of the medical information of the first individual, communicate for display the third one or more portions of the medical information of the first individual.

3. The system of claim 1, wherein the one or more processors are further operable to:
receive, from a third requestor, a third request to view the medical information associated with the first individual;
determine whether the third requestor has been given any permission levels by the first individual; and
following a determination that the third requestor has not been given any permission levels by the first individual, deny the third request to view the medical information associated with the first individual.

4. The system of claim 3, wherein the first requestor comprises a first health service provider, the second requestor comprises a second health service provider, and the third requestor comprises a third health service provider.

5. The system of claim 1, wherein:
the one or more permission levels given to the first requestor by the first individual comprise full permission, and the first one or more portions of the medical information comprise all of the medical information of the first individual; and
the one or more permission levels given to the second requestor by the first individual comprise one or more classification-specific permissions, and the second one or more portions of the medical information comprise only the one or more portions of the medical information that include content that is associated with classifications that match the classification-specific permissions given to the second requestor.

6. The system of claim 1, wherein:
the one or more permission levels given to the first requestor by the first individual comprise full permission, and the first one or more portions of the medical information comprise all of the medical information of the first individual; and
the one or more permission levels given to the second requestor by the first individual comprise one or more type-specific permissions, and the second one or more portions of the medical information comprise only the one or more portions of the medical information that include content that is associated with types that match the type-specific permissions given to the second requestor.

7. The system of claim 1, wherein:
the one or more permission levels given to the first requestor by the first individual comprise full permission, and the first one or more portions of the medical information comprise all of the medical information of the first individual; and
the one or more permission levels given to the second requestor by the first individual comprise one or more report-specific permissions, and the second one or more portions of the medical information comprise only the one or more portions of the medical information that include content that is associated with reports that match the report-specific permissions given to the second requestor.

8. A non-transitory computer readable medium comprising logic, the logic, when executed by a processor, operable to:
receive one or more clinical packets, each clinical packet comprising content associated with the health of one of a plurality of individuals;
for each of the received clinical packets, store the content as medical information for the associated one of the plurality of individuals;
receive, from a first requestor, a first request to view the medical information associated with a first individual;
following the first request, determine a first one or more portions of the medical information of the first individual, the first one or more portions of the medical information being associated with one or more permission levels given to the first requestor by the first individual;
following the determination of the first one or more portions of the medical information of the first individual, communicate for display the first one or more portions of the medical information of the first individual;
receive, from a second requestor, a second request to view the medical information associated with the first individual;
following the second request, determine a second one or more portions of the medical information of the first individual, the second one or more portions of the medical information being associated with one or more permission levels given to the second requestor by the first individual, the second one or more portions of the medical information being at least partially different from the first one or more portions of the medical information; and
following the determination of the second one or more portions of the medical information of the first individual, communicate for display the second one or more portions of the medical information of the first individual.

9. The computer readable medium of claim 8, wherein the logic, when executed by the processor, is further operable to:
receive, from a third requestor, a third request to view the medical information associated with the first individual; and
following the third request, determine a third one or more portions of the medical information of the first individual, the third one or more portions of the medical information being associated with one or more permission levels given to the third requestor by the first individual, the third one or more portions of the medical information being at least partially different from the first one or more portions of the medical information and the second one or more portions of the medical information; and
following the determination of the third one or more portions of the medical information of the first individual, communicate for display the third one or more portions of the medical information of the first individual.

10. The computer readable medium of claim 8, wherein the logic, when executed by the processor, is further operable to:
receive, from a third requestor, a third request to view the medical information associated with the first individual;
determine whether the third requestor has been given any permission levels by the first individual; and
following a determination that the third requestor has not been given any permission levels by the first individual, deny the third request to view the medical information associated with the first individual.

11. The computer readable medium of claim 8, wherein:
the one or more permission levels given to the first requestor by the first individual comprise full permission, and the first one or more portions of the medical information comprise all of the medical information of the first individual; and
the one or more permission levels given to the second requestor by the first individual comprise one or more classification-specific permissions, and the second one or more portions of the medical information comprise only the one or more portions of the medical information that include content that is associated with classifications that match the classification-specific permissions given to the second requestor.

12. The computer readable medium of claim 8, wherein:
the one or more permission levels given to the first requestor by the first individual comprise full permission, and the first one or more portions of the medical information comprise all of the medical information of the first individual; and
the one or more permission levels given to the second requestor by the first individual comprise one or more type-specific permissions, and the second one or more portions of the medical information comprise only the one or more portions of the medical information that include content that is associated with types that match the type-specific permissions given to the second requestor.

13. The computer readable medium of claim 8, wherein:
the one or more permission levels given to the first requestor by the first individual comprise full permission, and the first one or more portions of the medical information comprise all of the medical information of the first individual; and
the one or more permission levels given to the second requestor by the first individual comprise one or more report-specific permissions, and the second one or more portions of the medical information comprise only the one or more portions of the medical information that include content that is associated with reports that match the report-specific permissions given to the second requestor.

14. A method, comprising:
receiving, by one or more processors, one or more clinical packets, each clinical packet comprising content associated with the health of one of a plurality of individuals;
for each of the received clinical packets, storing, by one or more processors, the content as medical information for the associated one of the plurality of individuals;
receiving, by the one or more processors from a first requestor, a first request to view the medical information associated with a first individual;
following the first request, determining, by the one or more processors, a first one or more portions of the medical information of the first individual, the first one or more portions of the medical information being associated with one or more permission levels given to the first requestor by the first individual;
following the determination of the first one or more portions of the medical information of the first individual, communicating, by the one or more processors, for display the first one or more portions of the medical information of the first individual;
receiving, by the one or more processors from a second requestor, a second request to view the medical information associated with the first individual;
following the second request, determining, by the one or more processors, a second one or more portions of the medical information of the first individual, the second one or more portions of the medical information being associated with one or more permission levels given to the second requestor by the first individual, the second one or more portions of the medical information being at least partially different from the first one or more portions of the medical information; and
following the determination of the second one or more portions of the medical information of the first individual, communicating, by the one or more processors, for display the second one or more portions of the medical information of the first individual.

15. The method of claim 14, further comprising:
receiving, from a third requestor, a third request to view the medical information associated with the first individual; and
following the third request, determining a third one or more portions of the medical information of the first individual, the third one or more portions of the medical information being associated with one or more permission levels given to the third requestor by the first individual, the third one or more portions of the medical information being at least partially different from the first one or more portions of the medical information and the second one or more portions of the medical information; and
following the determination of the third one or more portions of the medical information of the first individual, communicating for display the third one or more portions of the medical information of the first individual.

16. The method of claim 14, further comprising:
receiving, from a third requestor, a third request to view the medical information associated with the first individual;
determining whether the third requestor has been given any permission levels by the first individual; and
following a determination that the third requestor has not been given any permission levels by the first individual, denying the third request to view the medical information associated with the first individual.

17. The method of claim 16, wherein the first requestor comprises a first health service provider, the second requestor comprises a second health service provider, and the third requestor comprises a third health service provider.

18. The method of claim 14, wherein:
the one or more permission levels given to the first requestor by the first individual comprise full permission, and the first one or more portions of the medical information comprise all of the medical information of the first individual; and
the one or more permission levels given to the second requestor by the first individual comprise one or more classification-specific permissions, and the second one or more portions of the medical information comprise only the one or more portions of the medical information that include content that is associated with classifications that match the classification-specific permissions given to the second requestor.

19. The method of claim 14, wherein:
the one or more permission levels given to the first requestor by the first individual comprise full permission, and the first one or more portions of the medical information comprise all of the medical information of the first individual; and
the one or more permission levels given to the second requestor by the first individual comprise one or more type-specific permissions, and the second one or more portions of the medical information comprise only the one or more portions of the medical information that include content that is associated with types that match the type-specific permissions given to the second requestor.

20. The method of claim 14, wherein:
the one or more permission levels given to the first requestor by the first individual comprise full permission, and the first one or more portions of the medical information comprise all of the medical information of the first individual; and
the one or more permission levels given to the second requestor by the first individual comprise one or more report-specific permissions, and the second one or more portions of the medical information comprise only the one or more portions of the medical information that include content that is associated with reports that match the report-specific permissions given to the second requestor.
